(19) United States
(12) Patent Application Publication
(10) Pub. No.: US 2012/0033028 A1
(43) Pub. Date: Feb. 9, 2012

(54) METHOD AND SYSTEM FOR MAKING VIDEO CALLS

(76) Inventors: William A. MURPHY, Glace Bay (CA); Gordon FREEDMAN, Ottawa (CA)

(21) Appl. No.: 13/198,085

(22) Filed: Aug. 4, 2011

Related U.S. Application Data
(60) Provisional application No. 61/370,502, filed on Aug. 4, 2010.

(51) Int. Cl. H04N 7/14

(52) U.S. Cl. 348/14.02; 348/E07.078

(57) ABSTRACT

A method comprises using a cellular telephone associated with a first party to transmit, during a first period of time, voice data from the first party to a second party via a cellular wireless telephone network. During the first period of time, a first video camera other than an integrated video camera of the cellular telephone is used to capture video data relating to the first party. The captured video data is transmitted to the second party via a communication network other than the cellular wireless telephone network. Audio content that is based on the voice data and video content that is based on the video data is provided to the second party, the audio content being synchronized with the video content.

This application claims the benefit of U.S. Provisional Patent Application No. 61/370,502, filed on Aug. 4, 2010, the entire contents of which are incorporated herein by reference.

### FIELD OF THE INVENTION

The instant invention relates generally to telecommunication methods and systems, and more particularly to a method and system for initiating video calls.

### BACKGROUND OF THE INVENTION

Telecommunication technologies allow two or more parties to communicate almost instantly, even over vast distances. In the early part of the last century, landline telephones became essentially ubiquitous in developed countries. More recently, cellular wireless telephone networks have emerged, allowing parties to communicate with one another from virtually anywhere within a cellular network coverage area.

Videoconferencing has also emerged recently as a viable alternative to voice-only communication. A videoconference is a set of interactive telecommunication technologies, which allow two or more parties to interact via two-way video and audio transmissions simultaneously. Webcams are popular, relatively low cost devices that can provide live video streams via personal computers, and can be used with many software clients for videoconferencing over the Internet.

Of course, videoconferencing requires significant bandwidth and is therefore not well suited for use over a cellular wireless telephone networks. That being said, many of the newer smart phones such as the HTC EVO 4G include a front facing camera to be used in video conferencing via cellular wireless telephone networks. Unfortunately, widespread adoption of videoconferencing via cellular wireless telephone networks is likely to strain the capabilities of current infrastructure. Furthermore, the majority of the cell phones that are currently in use do not include front facing cameras, making them incapable of providing video streams for videoconferencing.

It would be advantageous to provide a method and system for making video calls that overcomes at least some of the above-mentioned limitations of the prior art.

### SUMMARY OF EMBODIMENTS OF THE INVENTION

According to at least one of the embodiments of the instant invention, the voice data portion and the video data portion of a videoconference are transmitted between two or more parties via different communications networks. For instance, the voice data are transmitted via a cellular wireless telephone network whilst the video data are transmitted via an IP network. This approach reduces the network traffic on the cellular wireless telephone network, and results in reduced costs. One specific and non-limiting application is for large corporations as an enterprise wide system.

In accordance with an aspect of the invention there is provided a method comprising: using a cellular telephone associated with a first party, transmitting during a first period of time voice data from the first party to a second party via a cellular wireless telephone network; using a first video camera other than an integrated video camera of the cellular telephone, capturing during the first period of time video data relating to the first party; transmitting the captured video data to the second party via a communication network other than the cellular wireless telephone network; and, providing to the second party audio content based on the voice data and video content based on the video data, the audio content synchronized with the video content.

In accordance with an aspect of the invention there is provided a method comprising: receiving from a cellular telephone associated with a first party, via a cellular wireless telephone network, a request to initiate a cellular telephone call between the first party and a second party; determining a current location of the first party; identifying a first video camera located within a predetermined distance of the determined location of the first party; transmitting to the first party via the cellular wireless telephone network an alert relating to one of an indication that the first party is within a field of view of the first video camera and directions for guiding the first party to the first video camera.

In accordance with an aspect of the invention there is provided a method comprising: receiving from a cellular telephone associated with a first party, via a cellular wireless telephone network, a request to initiate a cellular telephone call between the first party and a second party; determining a current location of the first party; identifying a first video camera located within a predetermined distance of the determined location of the first party; capturing video data within a field of view of the first video camera; performing video analytics to identify the first party within the captured video data; and, in dependence upon identifying the first party within the captured video data, initiating a videoconference between the first party and the second party, comprising: using the cellular telephone associated with the first party, transmitting during a first period of time voice data from the first party to the second party via the cellular wireless telephone network; using the first video camera, capturing during the first period of time video data relating to the first party; and, transmitting the captured video data to the second party via a communication network other than the cellular wireless telephone network.

In accordance with an aspect of the invention there is provided a method comprising: using a cellular telephone associated with a first party, transmitting during a first period of time voice data from the first party to a second party via a cellular wireless telephone network; using an integrated video camera of the cellular telephone, capturing during the first period of time video data relating to the first party; transmitting the captured video data from the cellular telephone to a receiver via a Wi-Fi connection, the receiver remote from the cellular telephone and located within a predetermined distance of the first party; transmitting the captured video data from the receiver to the second party via a communication network other than the cellular wireless telephone network; and, providing to the second party audio content based on the voice data and video content based on the video data, the audio content synchronized with the video content.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified block diagram showing routing of video data and voice data, according to an embodiment of the instant invention;

FIG. 2 is a simplified block diagram showing routing of video data and voice data, according to an embodiment of the instant invention;

FIG. 3 is a simplified schematic diagram showing a system according to an embodiment of the instant invention;

FIG. 4 is a simplified schematic diagram showing a system according to an embodiment of the instant invention;

FIG. 5 is a simplified flow diagram of a method according to an embodiment of the instant invention;

FIG. 6 is a simplified flow diagram of a method according to an embodiment of the instant invention;

FIG. 7 is a simplified flow diagram of a method according to an embodiment of the instant invention; and,

FIG. 8 is a simplified flow diagram of a method according to an embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

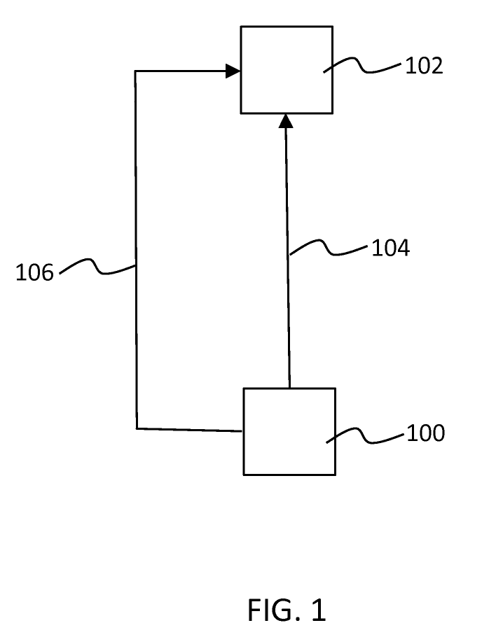

FIG. 1 is a simplified block diagram showing routing of video data and voice data, according to an embodiment of the instant invention. Voice data from a first party 100 is transmitted to a second party 102 via a first communication pathway 104 and video data from the first party 100 is transmitted to the second party 102 via a second communication pathway 106. The first communication pathway 104 includes a cellular wireless telephone network. Optionally, the first communication pathway 104 also includes at least one of an IP network, such as for instance the Internet, and the Public Switched Telephone Network (PSTN). The second communication pathway 106 does not include a cellular wireless telephone network. For instance, the second communication pathway 106 includes at least one of an IP network, such as for instance the Internet, and the PSTN.

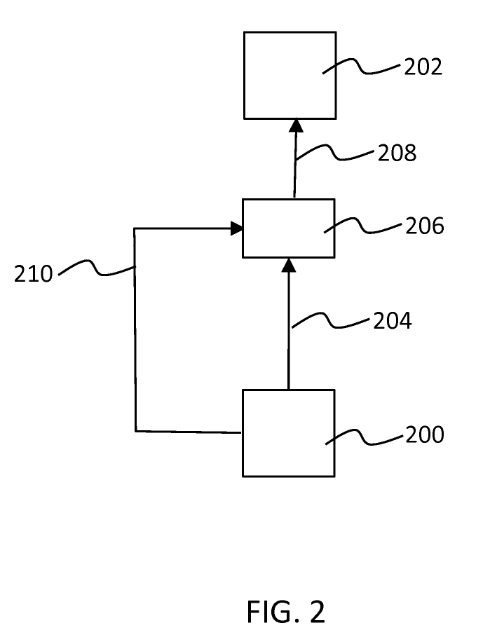

FIG. 2 is a simplified block diagram showing routing of video data and voice data, according to an embodiment of the instant invention. Voice data from a first party 200 is transmitted to a second party 202 via a cellular wireless telephone network 204, a gateway 206, and an IP network 208, such as for instance the Internet. Video data from the first party 200 is transmitted to the second party 202 via a Wide Area Network (WAN) or Local Area Network (LAN), shown generally at 210, the gateway 206, and the IP network 208. Optionally, the cellular wireless telephone network 204 connects to the PSTN, which in turn connects to the gateway 206. In the system that is shown in FIG. 2, video data is not transmitted via the cellular wireless telephone network 204.

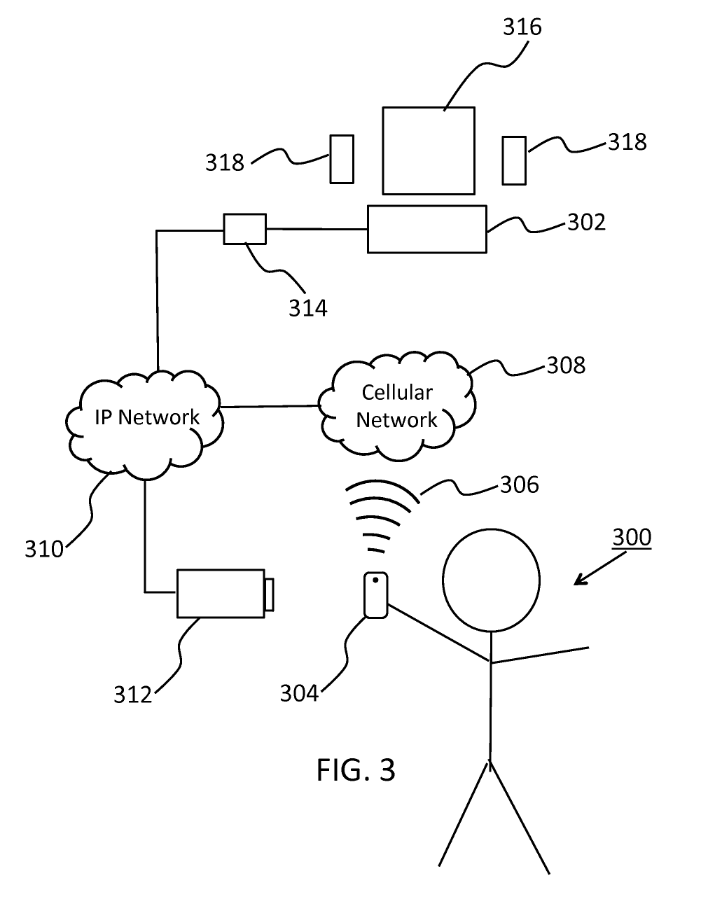

FIG. 3 is a simplified schematic diagram showing a system according to an embodiment of the instant invention. A first party 300 establishes a cellular telephone call with a system 302 of a second party, using cellphone 304. Voice data is carried over the air 306 and is transmitted via cellular network 308, which is connected to IP network 310. Video data is captured using video camera 312, and is transmitted via a communication channel, such as a landline, to IP network 310. The voice data and video data are transmitted via router 314 to the system 302. System 302 displays video content based on the video data and audio content based on the voice data, in a synchronized fashion, via display 316 and speakers 318, respectively.

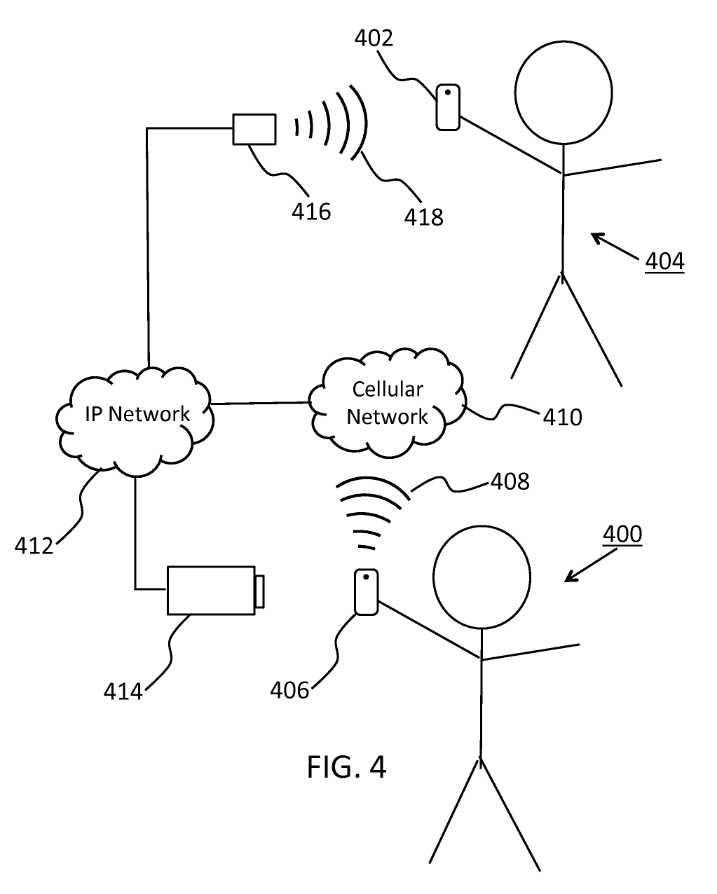

FIG. 4 is a simplified schematic diagram showing a system according to an embodiment of the instant invention. A first party 400 establishes a cellular telephone call with a device 402 of a second party 404, using cellphone 406. By way of a specific and non-limiting example, the device 402 is a portable device such as for instance a cellular telephone, a smart phone, or a media player device such as an iPod® Touch. The device 402 includes a Wi-Fi adapter. Voice data is carried over the air 408 and is transmitted via cellular network 410, which is connected to IP network 412. Video data is captured using video camera 414, and is transmitted via a communication channel, such as a landline, to IP network 412. The voice data and video data are transmitted via router 416 to the device 402. Device 402 displays video content based on the video data and audio content based on the voice data, in a synchronized fashion, via a display portion thereof and via a built-in speaker or external earphones, respectively.

Referring now to FIGS. 3 and 4, during use the cellular telephone 304 or 406 is used to initiate a cellular telephone call between the first party and the second party. In order to establish a videoconference between the first party and the second party, a not illustrated controller locates video cameras, other than an integrated video camera of the cellular telephone 304 or 406, within a predetermined distance from the first party. For instance, when the cellular telephone 304 or 406 is equipped with a GPS device, the controller determines the approximate location of the first party with a known error based on a signal from the GPS device. Optionally, other location data is used to determine the approximate location of the first party, such as cell tower triangulation techniques or a combination of GPS and cell tower triangulation techniques. Thereafter, the controller identifies public cameras that are connected to IP network 310 or 412, and that are within the known distance from the first party. The controller subsequently transmits an alert to the cellular telephone 304 or 306, in order to inform the first party either that he or she is within the field of view of a usable video camera or to provide directions for guiding the first party to one of the identified public cameras.

For instance, subsequent to receiving a request to initiate the cellular telephone call and determining the approximate location of the first party, the controller controls the one or more of the identified video cameras to capture video data. Video analytics is performed on the captured video data in order to attempt to identify the first party within the field of view one of the identified cameras. When the first party is identified within the field of view of one of the identified cameras, then an alert is transmitted to the first party informing them that teleconference functions are available. By way of a specific and non-limiting example, a camera view for the videoconference is created by “watching” a camera view that is on, in order to identify the first party using video analytics, and then repurposing the camera view for use in videoconferencing.

On the other hand, when the first party is not identified within the field of view of one of the identified cameras, or when the first party is not within a predetermined portion of the field of view of one of the identified cameras, then an alert is transmitted to the first party for either guiding the first party toward one of the identified cameras or for guiding the first party to the predetermined portion of the field of view. For instance, the predetermined portion of the field of view is selected to ensure that only the head and shoulders of the first party are captured in the video data, or to ensure that the top of the first party's head is not cut off in the video data, etc.

In particular, the above-mentioned identification using video analytics is based on stored profile data for the first party. By way of a specific and non-limiting example, the profile data for the first party is provided when the first party subscribes to a videoconferencing service, or is provided via a web portal, etc. Optionally, the identified video camera is specifically purposed for public use as a video capture device for videoconferencing using cellular telephones in public places. Alternatively, the identified video camera is a general-purpose security camera, which is installed in a business or other public space for monitoring activity within a known field of view. The identified camera may be capable of capturing high definition, full frame rate color video. Optionally, when a plurality of cameras is identified within the known distance from the first party, the alert that is sent to the first party includes directions for guiding the first party to the highest quality video camera.

When the first party enters the field of view of the identified video camera, the controller initiates a videoconference session automatically. In particular, the identified video camera captures video data of the first party during a time that the first party is talking into the cellular phone 304 or 406. The voice data portion of the videoconference session is transmitted from the first party to the second party via a cellular wireless telephone network. On the other hand, the video data portion of the videoconference session is not transmitted to the second party via the cellular wireless telephone network. Since video data, and in particular high definition, full frame rate video data, requires substantial bandwidth, the video data portion of the videoconference session is transmitted to the second party via high bandwidth communication channel, such as for instance via an IP network. The second party receives the video data and the voice data via the IP network, and the video data and the voice data are presented to the second party in a synchronized fashion. The systems that are shown in FIGS. 3 and 4 support transmission of high quality video data, concurrently with transmission of voice data over a cellular wireless telephone network, in a manner that does not result in significantly more network traffic than a voice-only cellular telephone call. Optionally, the controller prompts the first party to provide a confirmation signal prior to initiating the videoconference.

In an alternative embodiment, an integrated camera of the cellular telephone 304 or 406 is used to capture video data and the video data is transmitted via Wi-Fi to a receiver proximate the first user. The video data is transmitted from the receiver to the second party via a communications network not including a cellular wireless telephone network, such as for instance an IP network, whilst voice data is transmitted from the first party to the second party via a cellular wireless telephone network and the IP network. The second party receives the video data and the voice data via the IP network, and the video data and the voice data are presented to the second party in a synchronized fashion. In this case, it is not necessary to perform video analytics to identify the first party since the first party is using a camera integrated into the cellphone 304 or 406 to capture the video data. A recognition process is performed in which the cellphone 304 or 406 transmits video data to the receiver in association with an identifier relating to either the first party specifically, if individual profiles are established on the cellphone 304 or 306, or to the cellphone 304 or 306 generally. Advantageously, since the video data is captured using an integrated video camera of the cell phone, the user may move about a predetermined area that is equipped with a plurality of different receivers, the Wi-Fi communication between the cellphone 304 or 306 and a first one of the plurality of different receivers being handed off to a second receiver of the plurality of receivers as the first party moves out of range of the first receiver. In this way, the first party may walk through a shopping mall or office building, or another similar public or private area equipped with a plurality of receivers, and continue to provide video data to the second party during the cellphone call.

By way of a specific and non-limiting example, a Voice over Internet Protocol (VoIP) software client, such as for instance Skype®, is in execution on cellular telephone 304 or 406 in FIGS. 3 and 4. Such software clients support a videoconferencing function, wherein voice and video data is exchanged between two or more parties. According to an embodiment of the instant invention, during video conferencing the video data and the voice data are transmitted separately via different communications networks, the video data being transmitted via a first communications network with relatively higher bandwidth and the voice data being transmitted via a second communications network with relatively lower bandwidth. Optionally, portions of the first communications network and the second communication network overlap. That being said, the video data is not transmitted via a cellular wireless telephone network.

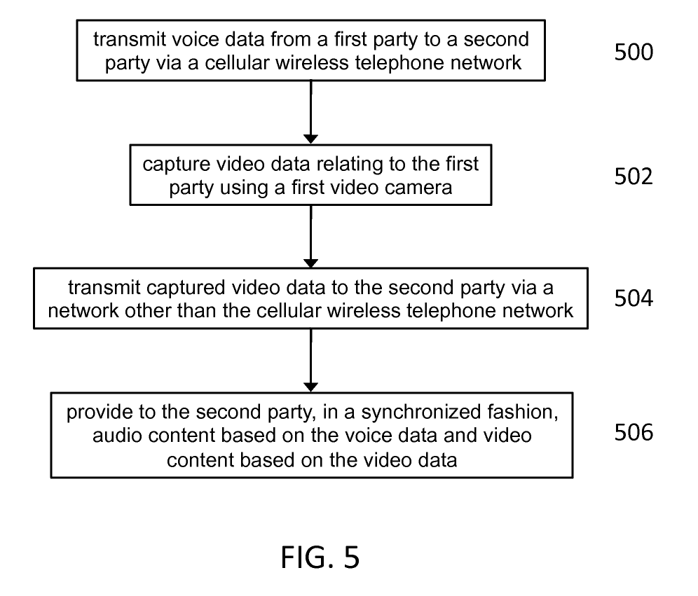

FIG. 5 is a simplified flow diagram of a method according to an embodiment of the instant invention. At 500, using a cellular telephone associated with a first party, voice data are transmitted during a first period of time from the first party to a second party via a cellular wireless telephone network. At 502, using a first video camera other than an integrated video camera of the cellular telephone, video data relating to the first party are captured during the first period of time. At 504 the captured video data are transmitted to the second party via a communication network other than the cellular wireless telephone network. At 506 audio content based on the voice data and video content based on the video data are provided to the second party, the audio content synchronized with the video content.

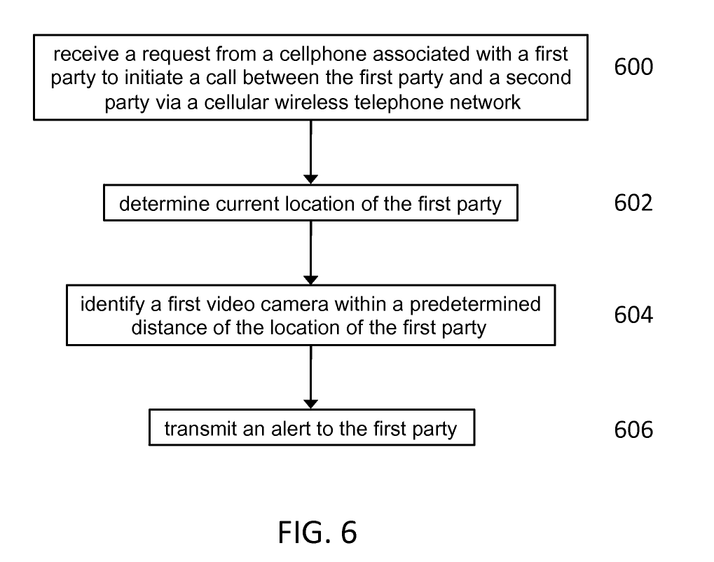

FIG. 6 is a simplified flow diagram of a method according to an embodiment of the instant invention. At 600 a request is received from a cellular telephone associated with a first party, via a cellular wireless telephone network, to initiate a cellular telephone call between the first party and a second party. At 602 a current location of the first party is determined. At 604 a first video camera located within a predetermined distance of the determined location of the first party is identified. At 606 an alert is transmitted to the first party via the cellular wireless telephone network. In particular, the alert relates to one of an indication that the first party is within a field of view of the first video camera and directions for guiding the first party to the first video camera. By way of a specific and non-limiting example, the directions are through integration with GPS based maps on the cellular wireless telephone. Optionally, the camera to which the first party is directed also identifies itself, such as for instance by beeping, flashing a light, taking an image of the first party and transmitting the image to the cellular wireless telephone, etc.

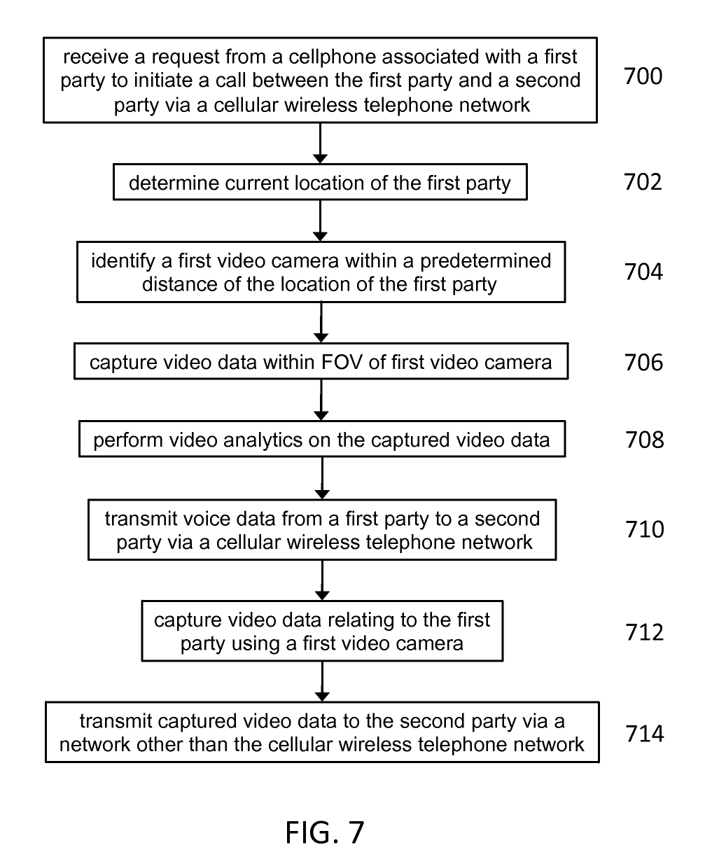

FIG. 7 is a simplified flow diagram of a method according to an embodiment of the instant invention. At 700 a request is received from a cellular telephone associated with a first party, via a cellular wireless telephone network, to initiate a cellular telephone call between the first party and a second party. At 702 a current location of the first party is determined. At 704 a first video camera located within a predetermined distance of the determined location of the first party is identified. At 706 video data are captured within a field of view of the first video camera. At 708 video analytics is performed to identify the first party within the captured video data. In dependence upon identifying the first party within the captured video data, a videoconference 710-714 is initiated between the first party and the second party. The videoconference comprises at 710, using the cellular telephone associated with the first party, transmitting during a first period of time voice data from the first party to the second party via the cellular wireless telephone network. At 712 video data relating to the first party are captured using the first video camera. At 714 the captured video data are transmitted to the second party via a communication network other than the cellular wireless telephone network.

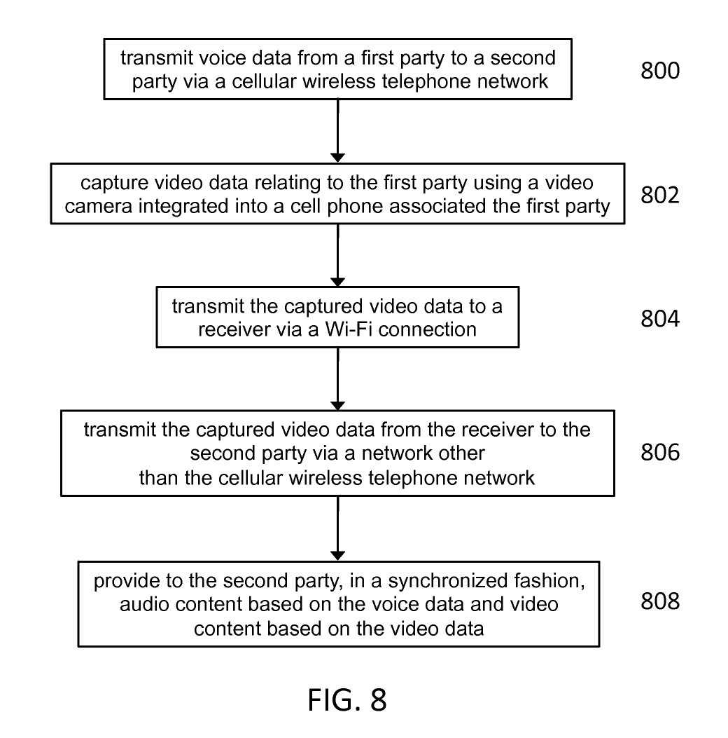

FIG. 8 is a simplified flow diagram of a method according to an embodiment of the instant invention. At 800, using a cellular telephone associated with a first party, voice data are transmitted during a first period of time from the first party to a second party via a cellular wireless telephone network. At 802, using an integrated video camera of the cellular telephone, video data relating to the first party are captured during the first period of time. At 804 the captured video data are transmitted from the cellular telephone to a receiver via a Wi-Fi connection. In particular, the receiver is remote from the cellular telephone and is located within a predetermined distance of the first party. At 806, the captured video data are transmitted from the receiver to the second party via a communication network other than the cellular wireless telephone network. At 808 audio content based on the voice data and video content based on the video data are provided to the second party, the audio content synchronized with the video content.

Numerous other embodiments may be envisaged without departing from the scope of the invention.

What is claimed is:

1. A method comprising:
using a cellular telephone associated with a first party, transmitting during a first period of time voice data from the first party to a second party via a cellular wireless telephone network;
using a first video camera other than an integrated video camera of the cellular telephone, capturing during the first period of time video data relating to the first party;
transmitting the captured video data to the second party via a communication network other than the cellular wireless telephone network; and,
providing to the second party audio content based on the voice data and video content based on the video data, the audio content synchronized with the video content.

2. A method according to claim 1, wherein the communication network other than the cellular wireless telephone network is an IP network.

3. A method according to claim 1, comprising performing video analytics on the captured video data to identify the first party within a field of view of the first video camera.

4. A method according to claim 3, wherein identifying the first party is based on stored template data for the first party.

5. A method according to claim 3, comprising displaying to the first party via the cellular telephone an alert for initiating videoconferencing when the first party is identified within the field of view of the first video camera.

6. A method according to claim 3, comprising displaying to the first party via the cellular telephone an alert for guiding the first party toward the first video camera when the first party is other than identified within the field of view of the first video camera.

7. A method comprising:
receiving from a cellular telephone associated with a first party, via a cellular wireless telephone network, a request to initiate a cellular telephone call between the first party and a second party;
determining a current location of the first party;
identifying a first video camera located within a predetermined distance of the determined location of the first party;
transmitting to the first party via the cellular wireless telephone network an alert relating to one of an indication that the first party is within a field of view of the first video camera and directions for guiding the first party to the first video camera.

8. A method according to claim 7, wherein determining a current location of the first party is based on Global Positioning System (GPS) information received from the cellular telephone.

9. A method according to claim 7, wherein determining a current location of the first party is based on cellphone tower triangulation techniques.

10. A method according to claim 7, wherein determining a current location of the first party is based on video analytics performed on video data that are captured using video cameras including the first video camera.

11. A method according to claim 7, comprising using the cellular telephone associated with the first party, transmitting during a first period of time voice data from the first party to the second party via the cellular wireless telephone network.

12. A method according to claim 11, comprising using the first video camera, capturing during the first period of time video data relating to the first party.

13. A method according to claim 12, comprising transmitting the captured video data to the second party via a communication network other than the cellular wireless telephone network.

14. A method according to claim 13, comprising providing to the second party audio content based on the voice data and video content based on the video data, the audio content synchronized with the video content.

15. A method according to claim 14, wherein the communication network other than the cellular wireless telephone network is an IP network.

16. A method comprising:
receiving from a cellular telephone associated with a first party, via a cellular wireless telephone network, a request to initiate a cellular telephone call between the first party and a second party;
determining a current location of the first party;
identifying a first video camera located within a predetermined distance of the determined location of the first party;
capturing video data within a field of view of the first video camera;
performing video analytics to identify the first party within the captured video data; and,
in dependence upon identifying the first party within the captured video data, initiating a videoconference between the first party and the second party, comprising:
using the cellular telephone associated with the first party, transmitting during a first period of time voice data from the first party to the second party via the cellular wireless telephone network;
using the first video camera, capturing during the first period of time video data relating to the first party; and,
transmitting the captured video data to the second party via a communication network other than the cellular wireless telephone network.

17. A method according to claim 16, wherein determining a current location of the first party is based on Global Positioning System (GPS) information received from the cellular telephone.

18. A method according to claim 16, wherein determining a current location of the first party is based on video analytics performed on video data that are captured using video cameras including the first video camera.

19. A method according to claim 16, wherein the communication network other than the cellular wireless telephone network is an IP network.

20. A method according to claim 16, wherein identifying the first party is based on stored template data for the first party.
